(19) United States
(12) Patent Application Publication
(10) Pub. No.: US 2026/0160423 A1
(43) Pub. Date: Jun. 11, 2026

(54) DEVICE, PREFERABLY OUTDOOR COOKING APPLIANCE, PARTICULARLY PREFERABLY OUTDOOR GRILL, MOST PREFERABLY OUTDOOR GAS GRILL

(71) Applicant: Miele & Cie. KG, Nordrhein-Westfalen (DE)

(72) Inventors: Leon Grothues, Sassenberg (DE); Peter Hollingsworth, Dortmund (DE)

(21) Appl. No.: 19/411,778

(22) Filed: Dec. 8, 2025

(30) Foreign Application Priority Data
Dec. 11, 2024 (DE) 102024137234.6

(51) Int. Cl. F24C 3/12; G06F 3/03; H01H 19/14

(52) U.S. Cl. CPC F24C 3/124; G06F 3/03; H01H 19/14

(57) ABSTRACT

A device, preferably an outdoor cooking appliance, particularly preferably an outdoor grill, most preferably an outdoor gas grill, having at least one first rotary knob which is designed to be turned by a person with one hand to operate the device, wherein the first rotary knob can be placed on a rotatable knob mount and removed from the rotatable knob mount by hand. The first rotary knob is designed, to close a connection of the device in the attached state to allow the operation of the device, and to open the connection of the device in the disconnected state to prevent the device from being operated.

### CROSS-REFERENCE TO RELATED APPLICATION

This application claims priority pursuant to 35 U.S.C. 119(a) to German Patent Office Application No. 102024137234.6, filed Dec. 11, 2024, which application is incorporated herein by reference in its entirety.

### FIELD OF THE INVENTION

The invention relates to a device, preferably an outdoor cooking appliance, particularly preferably an outdoor grill and most preferably an outdoor gas grill.

### BACKGROUND OF THE INVENTION

For a long time, food preparation has taken place in special rooms of buildings, which are called kitchens. There, kitchen appliances for the preparation and storage of food are provided as stationery, i.e., permanently arranged or built into kitchen units. These kitchen appliances include, for example, hobs and ovens, as well as refrigerators.

Grilling has also been used for a long time to prepare food. Grilled food is essentially cooked by heat radiation and roasted on the surface. Thorough cooking is achieved through heat transfer, also called conduction, from the surface of the food into the food itself.

Grilling can be done over an open fire, which is why it is usually practiced outdoors. Open fires can be produced using combustible materials, such as charcoal, but also using gas. The heat source is therefore a wood fire or embers, or a gas flame. Outdoor grilling can involve considerable effort, as a grill, fuel or gas source, and the food to be grilled, etc., have to be transported outdoors, set up, operated, and later dismantled and removed.

Alternatively, grilling can also be done using an electrically operated grilling device with electric heating coils, which can also be referred to as an electric grilling device. This has the advantage that, because an open fire is avoided, this type of grilling can also be done indoors. Mobile or stationary electric grills can be used for this purpose. However, the heating of outdoor grills with an electrically powered heat source is also known.

Electric grills are also becoming increasingly popular outdoors, as they offer various advantages compared to gas or charcoal grills. In particular, the ease of use, the comparatively fast heating behavior and the low emissions, e.g., due to no or only minimal fine dust development, are advantages. This also eliminates the need to procure, store, transport, and stow charcoal or gas cylinders at the location where the grill is used, which can also detract from the grill's appearance.

It is also well known nowadays to move other possibilities for preparing food, like the well-known barbecue grill, outside the kitchen or outside the house. Accordingly, such cooking appliances are referred to as outdoor kitchens, which are comparable to cooking appliances in the kitchen inside a house, also called indoor kitchens, and are powered by gas or electricity. Such outdoor kitchens can have, in addition to a grill, a hob and an oven, as well as storage space, a refrigerator and a sink. The aforementioned advantages of electric grills can also be implemented and utilized in outdoor kitchens. In any case, the outdoor grill usually represents the basic element or the “heart” of an outdoor kitchen.

However, gas-powered outdoor grills and outdoor kitchens are also widely available. Gas-powered outdoor grills, also called gas grills or outdoor gas grills, may, despite using gas as fuel, have an electrical 230V mains connection to use electric ignition to ignite the gas.

A disadvantage of such outdoor kitchens and separate or individual outdoor grills is that, especially if they are gas-powered, they tend to pose a higher risk of danger than electrically powered indoor appliances.

Furthermore, outdoor kitchens and outdoor grills are usually freely accessible to children and often unattended, as such equipment is typically left on the terrace or the like during the seasons of use. There is therefore a risk that children may start and operate the outdoor kitchen or outdoor grill unsupervised, thus creating a dangerous situation. Typically, any gas grill can be started and operated even by children with just a few simple steps. Safeguards and, in particular, child safety devices against such use are not known to date; at most, there are warning signs or stickers and instructions in the user manual.

Another disadvantage of such outdoor kitchens and outdoor grills, especially if they are gas-powered, is that they are comparatively expensive to purchase. Therefore, outdoor kitchens and outdoor grills, especially gas-powered ones, are at higher risk of theft than other objects. The risk of theft is increased by the fact that outdoor kitchens and outdoor grills are left outside at night and during vacation periods, making them more easily accessible to thieves than items inside the house.

These disadvantages can also apply to other devices.

Rotary controls, also known as rotary actuators or in the vernacular as rotary knobs, are used to operate technical devices or to adjust operating parameters of technical devices. A rotary control is a relatively small control element that can be adjusted by rotation and can be implemented using different functional principles. For example, potentiometers are typically used in electric rotary controls to detect the rotary position of the control relative to the technical device, so that a function can be performed depending on the rotary position selected by the user, for example to dim a luminous element. Mechanical rotary controls can, for example, be implemented as small operating elements for valves. It should be noted that, in contrast to what is called a “loop controller,” rotary controls are not actually a closed-loop control. Rather, a rotary control represents a purely controlling actuator.

Rotary knobs are used, for example, in kitchen appliances, such as hobs, ovens, microwaves, grills and the like, to adjust parameters, especially the power or power level. This applies to electrically operated hobs and grills as well as gas hobs and gas grills. On kitchen appliances, the rotary controls are usually referred to as rotary knobs, rotary dials, control dials, or simply as knobs or pommels.

Special anti-theft devices for outdoor kitchens and outdoor grills are not yet known. Purely mechanical locks and the like could be used as theft protection, but these can be overcome by the thief with some effort, so that the outdoor kitchen or outdoor grill could then be used by the thief without restriction.

The invention therefore addresses the problem of generally improving the possibilities of child safety and/or theft protection for devices. Preferably, an outdoor cooking appliance, and in particular an outdoor grill or outdoor kitchen, should be provided that is more child-safe and/or theft-proof than previously known. In particular, the device or outdoor cooking appliance should be able to be rendered non-functional to prevent being started or operated by unauthorized persons, such as children and/or thieves. In any case, operation by the user or owner should remain quick and easy. Preferably, an emergency stop function should also be provided, either additionally or as an alternative. This should preferably be as simple, cost-effective, flexible, visually unobtrusive, compact and/or reliable as possible. At the very least, an alternative to the known devices or outdoor cooking appliances of this kind should be created.

According to the invention, this object is achieved by a device and by a first rotary knob having the features of the independent patent claims. Advantageous embodiments and developments of the invention can be found in the following dependent claims.

The invention thus relates to a device, preferably an outdoor cooking appliance, particularly preferably an outdoor grill and most preferably an outdoor gas grill having at least one first rotary knob which is designed to be turned by a person with one hand to operate the device, wherein the first rotary knob can be both placed on a rotatable knob mount and removed from the rotatable knob mount by hand. Operating the device by turning the first rotary knob means that the device can thereby be put into operation or placed in a usable operating state, which can also be referred to as switching on, preferably from a completely inactive or switched-off state. Depending on the device, this may result in the device being connected to an electrical power supply or the galvanic isolation being removed from an electrical power supply. This can also include igniting a spark from a gas grill.

In any case, the device is characterized by the fact that the first rotary knob is designed,
to close a connection of the device in the attached state to allow operation of the device,

and,
to open the connection of the device in the disconnected state to prevent the device from being operated.

Thus, according to the invention, the first rotary knob, which can preferably be removed as a device for cleaning purposes in cooking appliances anyway, can be used to easily allow both a child safety protection and an anti-theft device. For this purpose, further development of known devices of this kind with rotary knobs is possible in such a way that a distinction can be made between the two states, whether the first rotatable knob is attached to the rotatable knob mount or removed from the rotatable knob mount, and the device can be operated depending on these two states or not. This can be implemented in a variety of technical ways, as will be described in more detail below.

According to one aspect of the invention, the connection is an electrically conductive connection. This can represent a particularly simple way of implementation, in that the circuit can be interrupted by removing the first rotary knob and closed again by putting on the first rotary knob. The opening and closing of the circuit or a central circuit of the device can take place at any point along the circuit, which can increase the design possibilities.

On the other hand, an interruption of the electrical circuit by removing the first rotary knob can also be circumvented relatively easily as a theft deterrent by bypassing and thereby eliminating the interruption caused by the removed rotary knob with an electrically conductive wire or the like.

According to a further aspect of the invention, the rotatable knob mount has a pair of electrically conductive contacts, wherein the first rotary knob has a recess for being placed on the knob mount, wherein the recess of the first rotary knob has an electrically conductive bridge which is configured to electrically connect the pair of electrically conductive contacts of the knob mount when placed on the knob. This can represent a concrete possibility for implementation, as previously described.

According to a further aspect of the invention, the electrically conductive connection is designed to close and open a circuit of a control unit for controlling the device, a circuit of an electrical power supply for powering the device and/or a circuit for operating the device. This can represent a concrete possibility for implementation, as previously described.

According to a further aspect of the invention, the connection is an inductive, capacitive and/or galvanic coupling. This can represent one alternative way, or alternative ways, to implement a distinction between an established or disconnected connection as described above. These types of coupling, whether individually or in combination, can increase the design possibilities and make them more difficult or even impossible for a thief to hotwire or overcome. However, this can negatively increase the effort required for implementation and thus the costs, the installation space, the susceptibility to errors, the risk of damage and failure, and the like.

According to a further aspect of the invention, the first rotary knob has a recess for being placed on the knob mount, wherein the recess of the first rotary knob is designed to establish inductive, capacitive and/or galvanic coupling when attached. This can represent a concrete possibility for implementation, as previously described in a similar way.

According to a further aspect of the invention, the device further comprises a control unit which is configured to detect inductive, capacitive and/or galvanic coupling, wherein the control unit is further configured
to allow operation of the device when an inductive, capacitive and/or galvanic coupling is detected, and,
to prevent operation of the device when an inductive, capacitive and/or galvanic coupling is undetected.

This can represent a concrete possibility for implementation, as previously described in a similar way.

According to a further aspect of the invention, the first rotary knob and the knob mount are designed to be compatible with each other with respect to their inductive, capacitive and/or galvanic coupling. This may increase the effort and lead to the risk that if the first rotary knob, which is individually suitable for the device, is lost, no other mechanically suitable rotary knob can be used and the device can no longer be operated, possibly until the knob mount is replaced. However, the advantage here is that the removed rotary knob cannot simply be electrically bypassed, thus creating improved theft protection.

According to another aspect of the invention, the connection is a communication connection. This can be an alternative possibility for implementing a distinction between an existing or disconnected connection as described previously. While this may increase the effort involved, it also expands the design possibilities. This can contribute to effective theft protection.

According to a further aspect of the invention, the first rotary knob has a recess for being placed on the knob mount, wherein the knob mount has a wireless receiver, preferably an RFID receiver, and wherein the recess of the first rotary knob has a wireless transmitter, preferably an RFID transmitter, or vice versa. This can represent a concrete implementation option, as previously described in a similar way.

According to a further aspect of the invention, the device comprises a control unit which is configured to detect the communication link, preferably between the wireless transmitter and the wireless receiver, wherein the control unit is further configured
to allow operation of the device when a communication connection is detected, and,
to prevent operation of the device if no communication connection is undetected.

This can represent a concrete implementation option, as previously described in a similar way.

According to another aspect of the invention, the wireless transmitter and the wireless receiver, preferably as an RFID transmitter and an RFID receiver, are individually encrypted to match each other. This can represent a concrete implementation option, as previously described in a similar way.

According to a further aspect of the invention, the first rotary knob is further designed to set an operating parameter of the device. Thus, the first rotary knob can perform two functions, eliminating the need for a second separate rotary knob or the like for setting the operating parameter of the device, which can save corresponding costs, installation space or space on a control panel or the like on the device.

According to a further aspect of the invention, the first rotary knob is designed to be turned by the person with one hand just for the purpose of operating the device, wherein the device further comprises at least a second rotary knob which is designed to be turned by the person with the hand just for the purpose of setting an operating parameter of the device, wherein the second rotary knob is preferably also attachable and detachable by hand. This allows these two functions to be separated and performed using separate rotary knobs, which can simplify the technical implementation and make things more intuitive and operable for the user.

The invention also relates to the first rotary knob for use in a device as described above. Thus, a first rotary knob can be provided, for example as a spare part or as a more visually appealing alternative to a first rotary knob provided by the manufacturer for the device, to implement and utilize the properties and advantages described above.

### BRIEF DESCRIPTION OF THE DRAWINGS

Multiple exemplary embodiments of the invention are shown purely schematically in the drawings and are described in more detail below. Shown are:

FIG. 1 is a frontal view of a device according to the invention in the form of an outdoor gas grill;

FIG. 2 is a representation of FIG. 1 from the left side;

FIG. 3 is a detailed cross-sectional view of an outdoor gas grill according to the invention in accordance with a first exemplary embodiment of the invention with a first rotary knob attached;

FIG. 4 is a representation of FIG. 3 with the first rotary knob removed;

FIG. 5 is a detailed cross-sectional view through an outdoor gas grill according to the invention in accordance with a second exemplary embodiment of the invention with a first rotary knob attached;

FIG. 6 is a detailed cross-sectional view through an outdoor gas grill according to the invention in accordance with a third exemplary embodiment of the invention with a first rotary knob attached;

FIG. 7 is a detailed cross-sectional view through an outdoor gas grill according to the invention in accordance with a fourth exemplary embodiment of the invention with a first rotary knob attached; and,

FIG. 8 is a representation of FIG. 7 with the first rotary knob removed.

The above figures are viewed in Cartesian coordinates. A longitudinal axis X, which can also be called depth X or length X, extends longitudinally. A transverse axis Y, which can also be referred to as the width Y, extends perpendicular to the longitudinal axis X. A vertical axis Z extends perpendicular to both the longitudinal axis X and the transverse axis Y; this axis can also be called height Z and corresponds to the direction of gravity. The longitudinal axis X and the transverse axis Y together form the horizontal X, Y, which can also be referred to as the horizontal plane X, Y.

### DETAILED DESCRIPTION OF THE INVENTION

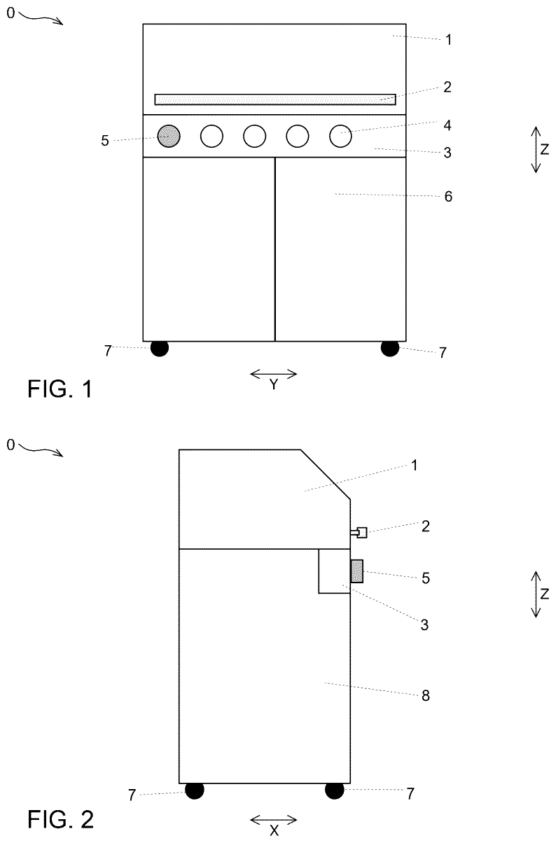

FIG. 1 shows a top view from the front of a device 1 according to the invention in the form of an outdoor gas grill 1. FIG. 2 shows the representation of FIG. 1 from the left side.

The outdoor gas grill 1 according to the invention has a frame (not specified) which stands on a surface (not shown), such as a terrace, with four rollers 7 arranged at the corners and can be moved there by rolling. In the lower region, the frame has side panels 8 on both sides and, toward the front, i.e., toward a user along the longitudinal axis X, a pair of front doors 6.

In the upper region, the frame has a front panel 3 with a first rotary knob 5 as an ignition and control dial 5 to start the ignition process or the outdoor gas grill 1, and to the right of it four second rotary knobs 4, which as gas dial burners 4 can regulate the amount of gas used for four cooking points heated with gas flames (not shown) by adjusting a control valve in each case with regard to the gas supply to the burner or burners. Both the ignition and control dial 5 and the gas dial burner 4 can be gripped and turned by a person as the user with one hand to use the relevant function.

The outdoor gas grill 1 is topped with a hood 1, which is pivotable to the rear and attached to the frame by means of hinges (not shown). For this purpose, the user can use a handle 2, which is arranged transversely at the front of the hood 1.

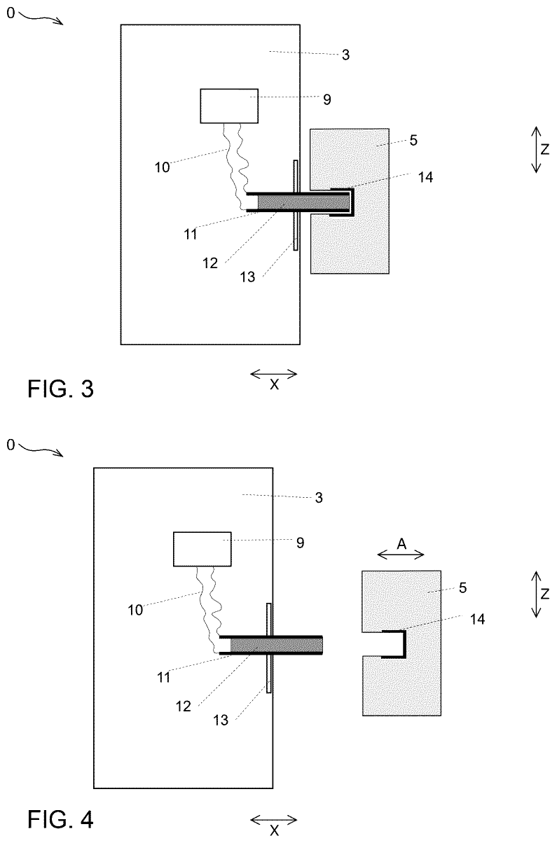

Thus, the outdoor gas grill 1 has various external operating options in the form of the ignition and control dial 5 as well as the gas dial burner 4, as already mentioned. The ignition or switching on of the outdoor gas grill 1 can be carried out directly or indirectly via a control unit 9 or via electronics 9. Furthermore, it is conceivable that the ignition and control dial includes 5 additional functions or is integrated within the gas dial 4. The ignition and control dial 5 is designed such that it can be pulled off a dial mount 12 by means of a pulling movement A and can be placed on the dial mount 12 by means of an opposite attaching movement A, see FIGS. 3 and 4.

In order to prevent the burners from igniting according to the invention when the ignition and control dial 5 has been removed from the outdoor gas grill 1, the electronics 9 are connected to the ignition and control knob 5 by means of an electrical connecting line 10 via two electrical contacts 11 on the dial mount 12, according to the first exemplary embodiment of FIGS. 3 and 4. The removable ignition and control dial 5 contains a bridge 14 which, in the attached state, establishes an electrical contact with the contacts 11 and closes the circuit to the electronics 9. If the ignition and control dial 5 is removed, the electrical circuit is opened and operation is prevented.

The electronics 9 can be general device electronics, control electronics or ignition electronics. The ignition of the burners can therefore be prevented by interrupting the power supply to the electronics 9, see FIGS. 3 and 4, by interrupting the circuit for the ignition spark or the ignition generator, or by evaluating the circuit (open/closed) for control electronics.

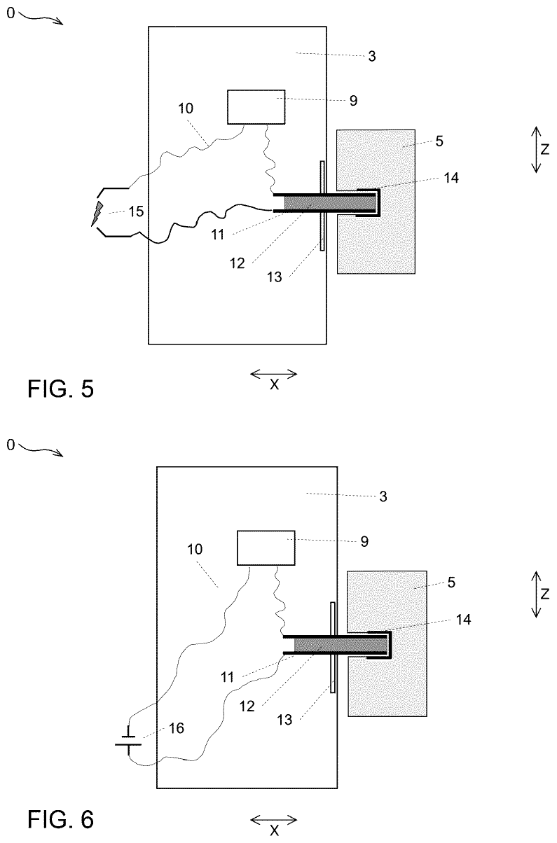

The electrical connecting lines 10 do not necessarily have to be directly connected to the electronics 9 but can also be connected to other components. FIG. 5 shows, for example, the version with a coupling directly to the spark gap 15 for the ignition of the gas. FIG. 6 shows, for example, the version with a coupling to a voltage source 16. Other design options are conceivable.

It should be noted that not all components necessarily have to be located within or outside the region of the front panel 3. The implementation may vary depending on the device architecture.

The implementation of dial detection can also include other design solutions, such as inductive or capacitive detection or detection via a resistor. Further implementations are conceivable.

Removing the ignition and control dial 5 renders the outdoor gas grill 1 inoperable. Operation by children or other persons is not possible unless they put on the ignition and control dial 5. This function can therefore be used as a child safety protection to reliably prevent unattended operation of the outdoor gas grill 1 by children in a simple way. Tampering with the outdoor gas grill 1 is difficult. The risk posed by unsupervised children in the region of the outdoor gas grill 1 is avoided or at least reduced.

This can also be used as an additional or alternative theft deterrent, although such a deterrent could be overcome by a thief using an electric wire or the like. The removable ignition and control dial 5 can therefore serve as a kind of key for the outdoor gas grill 1. Additionally, depending on the design, the ignition and control dial 5 can also be used as a kind of emergency stop.

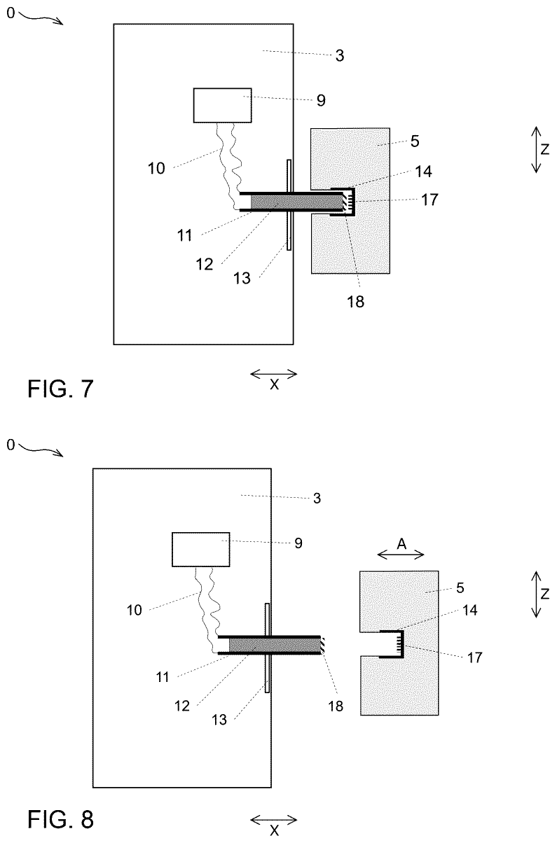

FIG. 7 shows a detailed cross-sectional view through an outdoor gas grill 1 according to the invention in accordance with a fourth exemplary embodiment of the invention with the first rotary knob 5 or ignition and control dial 5 attached. FIG. 8 shows the representation of FIG. 7 with the first rotary knob 5 or ignition and control dial 5 removed.

In this case, the ignition and control dial 5 and the dial mount 12 are equipped with an RFID system with RFID transmitter 17 and RFID receiver 18 as possible implementations of a wireless transmitter 17 equipped with a wireless receiver 18 and are encrypted accordingly, so that the outdoor gas grill 1 can only be started or operated with the matching RFID counterpart. This can prevent the outdoor gas grill 1 from being easily hotwired, which can improve theft protection.

### REFERENCE SIGNS

A Attaching/removing movement or direction
X Longitudinal axis; depth; length
Y Transverse axis; width
Z Vertical axis; height
X, Y Horizontal; horizontal plane
0 Device; outdoor cooking appliance; outdoor grill; outdoor gas grill
1 Hood
2 Handle
3 Front panel
4 Second rotary knobs; gas dial burner
5 First rotary knob; ignition and control dial
6 Front doors
7 Rollers
8 Side panel
9 control unit; electronics
10 Connecting line
11 Contact
12 Knob mount; dial mount
13 Fixation
14 Bridge
15 Spark gap
16 Electrical power supply; voltage source
17 Wireless transmitter; RFID transmitter
18 Wireless receiver; RFID receiver

1. A device, preferably an outdoor cooking appliance, particularly preferably an outdoor grill, most particularly preferably an outdoor gas grill, comprising
at least a first rotary knob which is designed to be turned by a person with one hand to operate the device, wherein the first rotatable knobcan be both attached to and removed from a rotary knob mount by hand, wherein the first rotary knob is formed,
to close a connection of the device in the attached state in order to allow the operation of the device, and,
to open the connection of the device in the disconnected state in order to prevent the device from being operated.

2. The device according to claim 1, wherein the connection is an electrically conductive connection.

3. The device according to claim 2, wherein the rotatable knob mount has a pair of electrically conductive contacts, wherein the first rotary knob has a recess to be placed on the knob mount, wherein the recess of the first rotary knob has an electrically conductive bridge which is designed to electrically connect the pair of electrically conductive contacts of the knob mount when attached.

4. The device according to claim 2, wherein the electrically conductive connection is configured to close and open a circuit of a control unit for controlling the device, a circuit of an electrical power supply for supplying the device and/or a circuit for operating the device.

5. The device according to claim 1, wherein the connection is an inductive, capacitive and/or galvanic coupling.

6. The device according to claim 5, wherein the first rotary knob has a recess to be placed on the knob mount, wherein the recess of the first rotary knob is designed to establish inductive, capacitive and/or galvanic coupling when attached.

7. The device according to claim 5, further having a control unit which is designed to detect inductive, capacitive and/or galvanic coupling, wherein the control unit is further designed
to allow the operation of the device when an inductive, capacitive and/or galvanic coupling is detected, and,
to prevent the operation of the device when an inductive, capacitive and/or galvanic coupling is not detected.

8. The device according to claim 5, wherein the first rotary knob and the knob mount are designed to be compatible with each other in terms of their inductive, capacitive and/or galvanic coupling.

9. The device according to claim 1, wherein the connection is a communication connection.

10. The device according to claim 9, wherein the first rotary knob has a recess to be placed on the knob mount, wherein the knob mount comprises a wireless receiver, preferably an RFID receiver, and wherein the recess of the first rotary knob has a wireless transmitter, preferably an RFID transmitter, or vice versa.

11. The device according to claim 9, further has a control unit which is configured to detect the communication link, preferably between the wireless transmitter and the wireless receiver, wherein the control unit is further designed
to allow operation of the device when a communication connection is detected, and,
to prevent the operation of the device when a communication connection is undetected.

12. The device according to claim 1, wherein the wireless transmitter and the wireless receiver, preferably as a RFID transmitter and as a RFID receiver, are individually encrypted to match each other.

13. The device according to claim 1, wherein the first rotary knob is further designed to set an operating parameter of the device.

14. The device according to claim 1, wherein the first rotary knob is designed to be turned by the person with one hand just for the purpose of operating the device, further having at least a second rotary knob which is designed to be turned by hand by the person just for the purpose of setting an operating parameter of the device, wherein the second rotary knob is preferably also able to be both attached and removed by hand.

15. A first rotary knob for use with a device according to claim 1.

16. The device according to claim 3, wherein the electrically conductive connection is configured to close and open a circuit of a control unit for controlling the device, a circuit of an electrical power supply for supplying the device and/or a circuit for operating the device.

17. The device according to claim 6, further having a control unit which is designed to detect inductive, capacitive and/or galvanic coupling, wherein the control unit is further designed
to allow the operation of the device when an inductive, capacitive and/or galvanic coupling is detected, and,
to prevent the operation of the device when an inductive, capacitive and/or galvanic coupling is not detected.

18. The device according to claim 6, wherein the first rotary knob and the knob mount are designed to be compatible with each other in terms of their inductive, capacitive and/or galvanic coupling.

19. The device according to claim 6, wherein the first rotary knob and the knob mount (are designed to be compatible with each other in terms of their inductive, capacitive and/or galvanic coupling.

20. The device according to claim 10, further has a control unit which is configured to detect the communication link, preferably between the wireless transmitter and the wireless receiver, wherein the control unit is further designed
to allow operation of the device when a communication connection is detected, and,
to prevent the operation of the device when a communication connection is undetected.
